(19) United States
(12) Patent Application Publication
(10) Pub. No.: US 2005/0005839 A1
(43) Pub. Date: Jan. 13, 2005

(54) Barrier materials and products produced therewith

(76) Inventors: Robert Moule, Penzanle (GB); Simon Moule, London (GB)

Correspondence Address: William Nitkin, Suite 300, 1320 Centre Street, Newton, MA, 02459, US

(21) Appl. No.: 10/913,242

(22) Filed: Aug. 6, 2004

Related U.S. Application Data
(63) Continuation-in-part of application No. 09/600,359, filed on Sep. 21, 2001.

(30) Foreign Application Priority Data
Jan. 16, 1998 (GB) 9800814.7

(51) Int. Cl. G01K 11/00

(52) U.S. Cl. 116/219

(57) ABSTRACT

A marking element is disclosed for indicating whether a predefined temperature condition has been maintained. The marking element has a first material capable of flowing when exposed to a temperature above a predefined temperature separated from an absorbent second material by a heat-disruptable barrier layer. The first and second materials are such that when the heat-disruptable barrier layer is punctured and the predefined temperature is exceeded, the first material flows into the absorbent second material to produce a detectable change. The heat-disruptable barrier layer is formed of a heat-disruptable material associated with an element capable of being inductively heated by electromagnetic energy to effect disruption of such layer, thereby activating the marking element.

This application is a continuation-in-part of our previous application entitled Barrier Materials and Products Produced Therewith filed Jul. 14, 2000 Ser. No. 09/600,359, now pending which is the U.S. national stage of PCT/GB99/00044 filed Jan. 18, 1999 which claims priority of GB9800814.7 filed Jan. 16, 1998, all of which are incorporated herein by reference.

### BACKGROUND OF THE INVENTION

1. Field of the Invention

The present invention resides in the field of heat disruptable barrier materials and more particularly relates thin plastic films and the disruption of such materials and to products, such as marking elements incorporating these materials.

2. History of the Prior Art

There are numerous examples of products incorporating barrier materials which must be disrupted, e.g. punctured, to allow communication between both sides of the barrier material. Examples of such products include containers which contain food to be microwaved and which are covered with a film or the like which must be punctured prior to the food being microwaved to ensure that steam is vented from the container. While it may be a relatively simple task manually to puncture the film for a single product item, it obviously becomes time consuming to repeat the operation for a plurality of items, e.g. when catering on a commercial scale.

A further problem of puncturing barrier layers occurs when the barrier is beneath a further layer which itself must not be punctured. A particular example of this problem is encountered in the marking element disclosed in WO-A-9208113 which is used for indicating whether a product has been maintained under a particular temperature or temperature-time condition. More particularly the marking element as manufactured comprises an ink separated from an absorbent wick by a heat-disruptable film, all of these components being provided beneath an upper film layer of higher melting/softening temperature than the heat-disruptable film.

By way of further explanation, the marking element may be one which is to be used for indicating whether frozen food has been stored at a higher temperature, e.g. room temperature, than is required. As such, the ink is one which is not capable of flowing at the correct storage temperature of the food, but is capable of flowing at or above the temperature at which the food should not be stored. When the marking element is manufactured, it is necessary to ensure that the ink, which will flow at the manufacturing temperature, is separated from the wick, hence the need for the barrier layer.

Subsequent to manufacture, the marking element is cooled down, either before or after application to the product to be monitored, to a temperature at which the ink will not flow. The element is then “activated” by application of a heated probe to the upper film layer. This probe is at a temperature at which it does not disrupt the outer film layer but is capable of puncturing the heat disruptable layer so as to allow the ink to reach the wick. If thereafter the temperature of the product increases beyond a predefined value, then the ink is capable of flowing in the wick to provide an indication of the undesired increase in temperature.

While such marking elements function in a perfectly satisfactory manner, the need to use a heated probe makes it difficult to activate the elements, particularly if they have already been applied to the product to be monitored.

### SUMMARY OF THE INVENTION

It is an object of the present invention to obviate or mitigate the above-mentioned disadvantages.

According to a first aspect of the present invention there is provided a marking element for indicating whether a predefined temperature condition has been maintained comprising a first material capable of flowing above a predefined temperature separated from an absorbent second material by a heat-disruptable barrier layer, the first material and absorbent second material being such that when the heat-disruptable barrier layer is punctured and then the predefined temperature is exceeded, the first material flows into the absorbent second material to produce a detectable change wherein the heat-disruptable barrier layer is comprised of a heat-disruptable material associated with an element capable of being inductively heated by electromagnetic energy to effect the disruption and puncturing of such material.

According to a second aspect of the present invention, there is provided a method of activating a marking element as defined in the previous paragraph, the method comprising subjecting the marking element to electromagnetic energy capable of inductively heating such inductive heatable element to effect disruption and puncture of the barrier layer.

The heat-disruptable material can, for example, be a film, most preferably a plastic film.

The inductively heatable element can be of any material having the requisite conductivity, e.g. metal, carbon or a conductive plastic or polymeric material. Conveniently the inductively heatable element is provided by a marking of an electrically conductive, e.g. metallic ink or metallic patch disposed on or otherwise associated with the heat-disruptable material. Further possibilities for the inductively heatable element are a foil, sheet or film of a metal. A still further possibility is a marking of a graphite (carbon) loaded ink.

The inductively heatable element can be disposed on either side of, or within, the barrier layer and can be of any desired shape, e.g. a disc or an annulus, appropriate to the electromagnetic energy to be used. The annulus can be of uniform width across its inner and outer edges, e.g. as provided by two concentric circles, or can have one or more “restrictions” around its width.

Preferably the electromagnetic energy for inductively heating the marking element is radio frequency energy (10⁴ Hz to 3×10¹² Hz). Preferably the frequency is from 50 kHz to 1 MHz, more typically 100 kHz to 500 kHz, e.g. 160 kHz to 180 kHz. In a preferred embodiment, the power can be 100 W to 1000 W, typically 500 W.

In the marking element according to the invention, the barrier layer together with the first and second materials can be provided beneath an outer layer, e.g. an outer film layer. The barrier layer can be selectively disrupted by the use of electromagnetic energy of the appropriate frequency, thus avoiding the need for the outer layer to be of a higher melting/softening temperature than the barrier layer and the need to use a heated probe. A related advantage is that the marking element can be activated simply by positioning the element, e.g. in situ on a product to be “monitored” by the marking element, close to an electromagnetic field of the appropriate frequency to effect disruption of the barrier layer. This procedure is a much more convenient technique to use than the use of a heated probe.

The barrier material as employed in the marking element of this invention is an important feature of the invention in its own right and therefore according to a third aspect of the present invention there is provided a barrier material comprised of a heat-disruptable material associated with an element capable of being inductively heated by electromagnetic energy to effect disruption of the barrier material.

According to a fourth aspect of the present invention there is provided a method of disrupting a barrier material as defined in the previous paragraph, the method comprising the steps of subjecting the barrier material to electromagnetic energy capable of inductively heating the inductively heatable element to effect disruption and puncturing of the barrier material.

The electromagnetic energy can be microwave energy such that the barrier material of the invention can be used, for example, as a covering for a container which is intended to be heated in a microwave oven. As such, the microwave energy effects inductive heating of the marking element, resulting in the disruption of the covering; and the need for manual puncturing is avoided.

The barrier material of the invention is particularly suitable for use in products in which a barrier to be punctured is provided beneath at least one further layer which is required to remain intact. By using electromagnetic energy it is possible to disrupt selectively only the barrier layer.

### BRIEF DESCRIPTION OF THE DRAWINGS

FIG. 1 illustrates an exploded perspective view of one embodiment of the marking element in accordance with the first aspect of the invention.

FIG. 2 illustrates a cross-sectional view of the marking element illustrated in FIG. 1 prior to activation thereof.

FIG. 3 illustrates a cross-sectional view similar to FIG. 2 but showing the marking element in an activated condition and also indicating that a product bearing the marking element has been stored above a predefined temperature.

FIG. 4 illustrates a top plan view of a marking element in the condition shown in FIG. 3.

### DESCRIPTION OF THE PREFERRED EMBODIMENT(S)

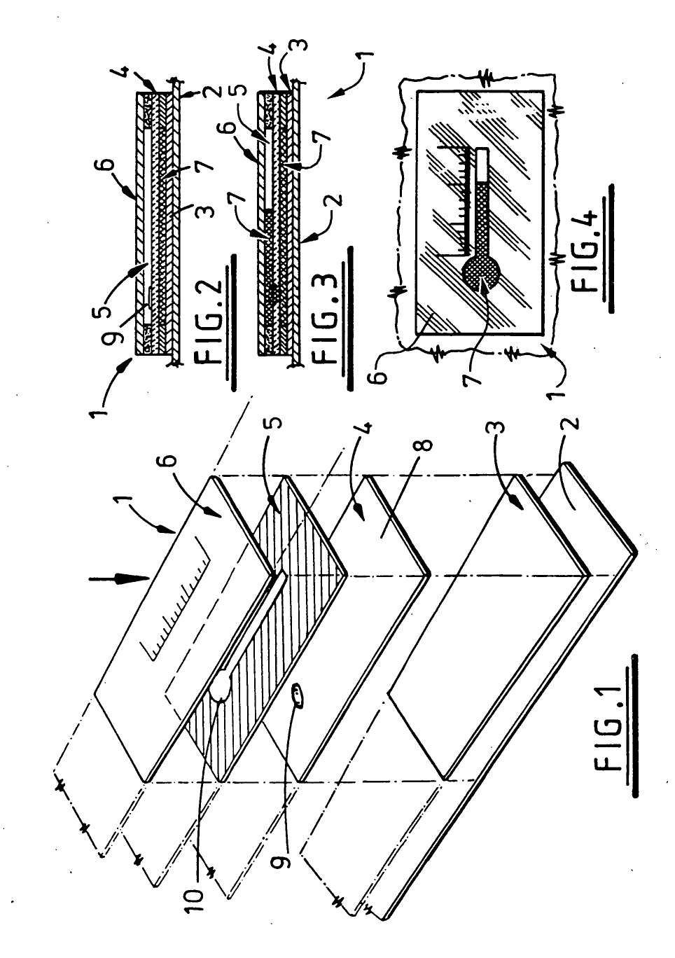

As shown in FIG. 1, marking element 1 in accordance with the invention is removably mounted on carrier sheet 2 and is a laminar structure comprised of layers 3-6 described in more detail below and ink 7, not shown in FIG. 1 but seen in FIGS. 2 and 3.

As seen in FIG. 1 in more detail, layer 4 is comprised of a heat-disruptable plastic film 8 provided with an inductively heatable element in the form of marking 9 of an inductively heatable conductive ink. Alternatively the inductively heatable element can, for example, be provided by a thin metal disc or a metal joint. At its under surface barrier layer 4 is bonded around its peripheral surface to the corresponding area of the upper surface of layer 3 so that a reservoir space (in which ink 7 is located) is formed between layers 3 and 4. The under surface of layer 3 is releasably attached to carrier sheet 2 so that marking element 1 can be removed therefrom and attached (by adhesive) to a product to be monitored.

Indicator layer 5 is composed of paper which has been treated with a resin so that only a central area 10, as seen in FIG. 1 in the shape of a thermometer, remains absorbent, the remaining area of indicator layer 5 as depicted by the hatched lines being nonabsorbent. The under surface of indicator layer 5 is bonded in the hatched areas to the upper surface of barrier layer 4, and it will be noted from FIG. 1 that marking 9 of reflective ink (on barrier layer 4) locates immediately beneath the “bulb” of the thermometer-shaped absorbent area 10 of indicator layer 5.

Layer 6 is a clear plastic layer which overlies, and is bonded to, indicator layer 5. Absorbent area 10 is of contrasting color to the color of ink 7.

In marking element 1, as seen in FIGS. 1 and 2, barrier layer 4 prevents contact between ink 7 and absorbent area 10 of indicator layer 5. Ink 7 is one which, once barrier layer 4 has been disrupted as discussed below, is only capable of flowing into absorbent area 10 of indicator layer 5 when the marking element has been exposed to a temperature above a predefined temperature. The ink can, for example, comprise an alkyl (particularly a C₁₄ alkyl) ester of a long-chain fatty acid. Examples of esters which can be used include ethyl myristate, butyl myristate and butyl laurate. It will of course be appreciated that the ink can comprise a mixture of esters to ensure that the ink flows above a particular temperature. In a further embodiment the ink can comprise a polymeric material which reversibly fuses above a predefined temperature, e.g. a thermo-reversible wax. Inorganic salts, e.g. sodium or potassium chloride, can also be incorporated in the polymeric material for providing the required temperature of fusion.

For the purposes of “activation” the marking element 1 is subjected to a temperature at which ink 7 will not flow. Subsequently, marking element 1, which can be attached to the product to be monitored, is placed close to an electromagnetic field of sufficient energy (flux density) to effect inductive heating of marking 9. This exposure causes disruption, i.e. puncturing, of barrier layer 4, as depicted in FIG. 3, beneath the “bulb” shape of absorbent area 10 of indicator layer 5 which therefore comes into communication with the reservoir of ink 7.

Provided that the product to which marking element 1 is attached is maintained below a predefined temperature, the ink is unable to flow, or at least unable to flow to any substantial extent, and does not color absorbent area 10. If, however, the temperature of the product is raised above the predefined temperature, then the ink will flow into, and indelibly mark, area 10, as depicted in FIGS. 3 and 4.

Barrier materials of similar construction to barrier layer 4 can be used in applications other than as a marking element. Such layers can, for example, be used as a covering for a container which is intended to be heated in a microwave oven such that inductive heating of the inductively heatable element results in disruption of the covering.

Although the present invention has been described with reference to particular embodiments, it will be apparent to those skilled in the art that variations and modifications can be substituted therefor without departing from the principles and spirit of the invention.

1. A marking element for indicating whether a predefined temperature condition has been maintained, comprising:
a first material which flows when it reaches a temperature above a predefined temperature;
a heat-disruptable barrier layer;
an absorbent material separated from said first material by said heat-disruptable barrier layer, said first material and said absorbent material being such that when said heat-disruptable barrier layer is punctured and said predefined temperature is exceeded, said first material flows into said absorbent material to produce a detectable change wherein said heat-disruptable barrier layer is comprised of a heat-disruptable material and further includes an inductively heatable element which, when inductively heated by electromagnetic energy, effects disruption and said puncturing of said heat-disruptable barrier layer.

2. The marking element of claim 1 further including a lower layer which, together with said heat-disruptable barrier layer, forms a reservoir for said first material.

3. The marking element of claim 2 further including a transparent film overlaying said absorbent material.

4. The marking element of claim 2 wherein said heat-disruptable material is a film.

5. The marking element of claim 4 wherein the heat-disruptable material is a plastic film.

6. The marking element of claim 1 wherein said inductively heatable element is a conductive ink.

7. The marking element of claim 6 wherein said conductive ink is selected from the group of metallic ink and graphite loaded ink.

8. The marking element of claim 1 wherein said inductively heatable element is selected from the group of metal, carbon, electrically conductive plastic and electrically conductive polymeric material.

9. The marking element of claim 8 wherein said inductively heatable element is made of metal in a form selected from the group of a film, a sheet or a foil.

10. The marking element of claim 1 wherein said heat-disruptable barrier layer is disrupted by radio frequency energy.

11. The marking element of claim 1 wherein said heat-disruptable barrier layer is disrupted by microwave energy.

12. A method of determining whether a marking element has been maintained at a temperature below a predefined temperature, comprising the steps of
providing said marking element with a first material which flows when exposed to a temperature above said predefined temperature;
providing an absorbent material in said marking element;
providing a heat-disruptable barrier layer separating said first material from said absorbent material;
heating said marking element by electromagnetic energy;
puncturing said barrier layer by said heating;
causing said first material to flow into said absorbent material through said punctured barrier layer when said first material is heated above said predefined temperature; and
providing a detectable change in said absorbent material indicating that the temperature of said marking element has exceeded said predefined temperature.
